(19) United States
(12) Patent Application Publication
(10) Pub. No.: US 2004/0158491 A1
(43) Pub. Date: Aug. 12, 2004

(54) Point system and method of providing an item being sold

(75) Inventor: Tadatsugu Ishii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/656,157

(22) Filed: Sep. 8, 2003

(30) Foreign Application Priority Data
Sep. 19, 2002 (JP) 2002-273180

(51) Int. Cl. G06F 17/60

(52) U.S. Cl. 705/14

(57) ABSTRACT

A point system for promoting sales of a product by persuading a user to purchase the product is provided. In this point system, predetermined points are generated in response to the purchase of an item being sold. The system includes a user terminal having an item specification unit that is used by a user to specify the item being sold. Additionally, there is a provider terminal connected to the user terminal via a network, which has a user points maintaining unit that is arranged to add the generated points to already accumulated points of the user and maintain the resulting points. A user points processing unit is arranged to allocate the points of the user maintained in the user points maintaining unit to a subtotal for the purchase of the specified item being sold. The user points processing unit is further arranged to be capable of increasing the points of the user maintained in the user points maintaining unit and allocating the increased points to the subtotal for the purchase of the specified item being sold when the user purchases the item during a predetermined time period or in a case where a condition relating to the user satisfies a pre-designated condition.

### BACKGROUND OF THE INVENTION

1. Field of the Invention

The present invention relates to a point system and a method of providing an item being sold, such as selling a product or offering a service.

2. Description of the Related Art

Currently, point systems are being used in many stores and online shopping sites.

In these point systems, certain points are given to a user when the user takes a predetermined action such as purchasing a product, using a service, registering for membership, browsing a particular website, and answering a questionnaire.

The user can accumulate the above points and use these points as a substitute for money to buy a product, or to receive a service, or the user may get a free gift in exchange for the points.

As an example of a prior art invention relating to the above described point system, in Japanese Patent Laid-Open Publication No.2000-268260, a configuration is disclosed wherein points of a point coupon are converted into prepaid coupons mainly for the payment of small sums, and an exchange rate for converting the points into prepaid coupons is changed according to the accumulation state of the points.

Also, in Japanese Patent Laid-Open Publication No.9-27083, a point reserve system is disclosed wherein the updating of the accumulated points can be performed in real time so that the customer (user) will be able to receive and use the points instantly.

However, the following problems exist in the above-described prior art examples.

The providers of products and services of a store or an online shopping site use the point system in the hopes of persuading a user (buyer of a product or user of a service) to use the accumulated points to purchase a high-priced product (or service).

However, in the case of offering a high-priced product, the amount of money converted from the accumulated points held by the user is normally significantly less than the price of the product. Thus, the accumulated points are not conventionally used for purchasing the high-priced product and instead, a free gift or a particular service may be offered in exchange for the accumulated points.

Thus, a problem in the conventional art is that the introduction of the point system does not necessarily lead to a boost in product sales as intended by the provider of the products or services.

### SUMMARY OF THE INVENTION

Accordingly, it is an object of the present invention to persuade a user to purchase a product or service and to promote sales of the product or service.

In the present invention, the above object is realized by increasing the points maintained by the user when the user purchases a product under certain conditions. In the present specification, the term ‘product’ refers not only to goods but also to any form of marketed item including services offered by a provider for which a user pays a price to receive.

Also, when a user purchases a product, the points that may be used by the user for purchasing the product may be increased with respect to the points that the user currently has, and the increased points that may be used upon purchase may vary (the points added may vary) depending on the product being purchased by the user. Further, the increased points that may be use upon the purchase may be set differently depending on the price of the product, how new the product is, and the popularity of the product, for example.

Also, the increased points that may be used upon purchase may be determined depending on the points that the user currently has.

Additionally, the increased points that may be used upon purchase may be determined with respect to the points currently held by the user when the user purchasing a product belongs to a specific group that is affiliated with the provider of the products.

Additionally, a notification that points will be increased with respect to the points the user currently has can be posted where the user is able to check the price of the product.

More specifically, the present invention provides a point system in which predetermined points are generated (points to be added) in response to the purchase of an item being sold, the system including:

a user terminal including an item specification unit used by a user to specify the item being sold; and

a provider terminal connected to the user terminal via a network, and including:

a user points maintaining unit that is arranged to add the generated points to the already accumulated points of the user and maintain the resulting points; and

a user points processing unit that is arranged to allocate the points of the user maintained in the user points maintaining unit to a subtotal for the purchase of the specified item being sold, wherein:

the user points processing unit is further arranged to be capable of increasing the points of the user maintained in the user points maintaining unit and allocating the increased points to the subtotal for the purchase of the specified item being sold when the user purchases the item during a predetermined time period or in a case where a condition relating to the user satisfies a pre-designated condition.

According to another aspect, the present invention provides a method of providing an item being sold in which predetermined points are generated in response to the purchase of the item being sold that is specified by a user using an item indicating unit, the method including:

a user points maintaining step of adding the generated points to the already accumulated points of the user and maintaining the resulting points; and

a user points processing step of allocating the points of the user maintained by the user points maintaining step to a subtotal for the purchase of the specified item being sold; wherein:

the user points processing step is further arranged to be capable of increasing the points of the user maintained by the user points maintaining step and allocating the increased points to the subtotal for the purchase of the specified item being sold when the user purchases the item being sold during a predetermined time period or in a case where a condition relating to the user satisfies a pre-designated condition.

According to the present invention, points currently maintained by a user may be increased when the user purchases a product under predetermined conditions and the user may be allowed to use the increased points to purchase this product. In this way, the user may be persuaded to purchase high-priced products in order to benefit from the increased points.

In turn, by persuading the user to purchase high-priced products, the provider of the product (seller) may be able to increase sales profit.

### BRIEF DESCRIPTION OF THE DRAWINGS

FIG. 1 is a diagram showing an example of an overall configuration of an online shopping system implementing a point system according to an embodiment of the present invention;

FIG. 2 is a table showing an example of user management information stored in a user management information database;

FIG. 3 is a table showing an example of product information of products sold in the online shopping system stored in the product management information database;

FIG. 4 is a diagram illustrating an overall operation of the point system according to an embodiment of the present invention;

FIG. 5 is a flowchart illustrating the generation of a transaction screen, which is a part of the operation of the point system according to an embodiment of the present invention; and

FIG. 6 is a diagram showing an example of the transaction screen generated according to an embodiment of the present invention.

### DESCRIPTION OF THE PREFERRED EMBODIMENTS

In the following, preferred embodiments of the present invention are described with reference to the accompanying drawings.

A point system according to an embodiment of the present invention is used in an online shopping system. It should be noted, however, that the present invention is not limited to this embodiment. Rather, the point system of the present invention may also be used at a store, or at a card company, for example.

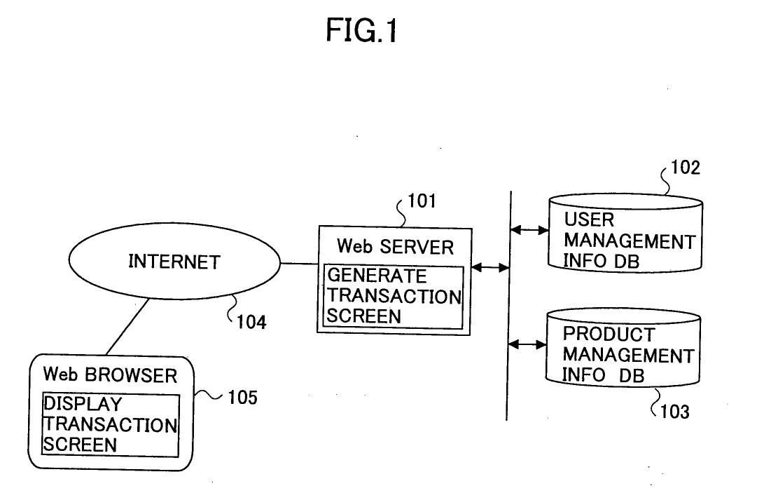

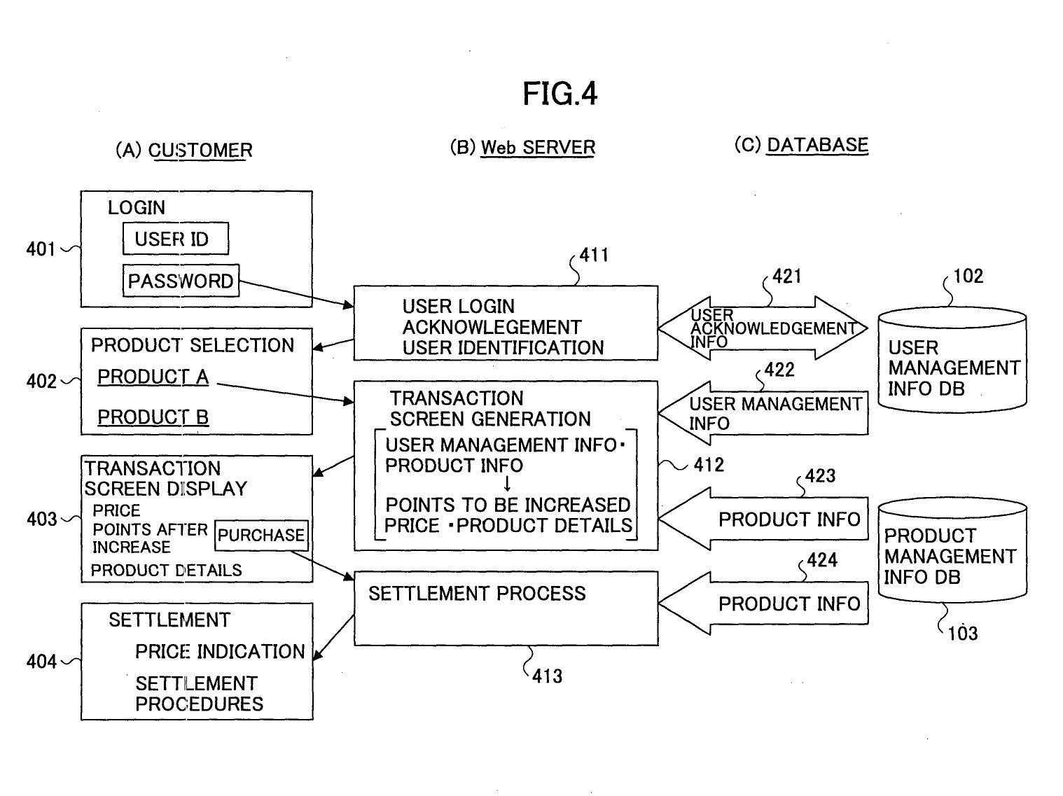

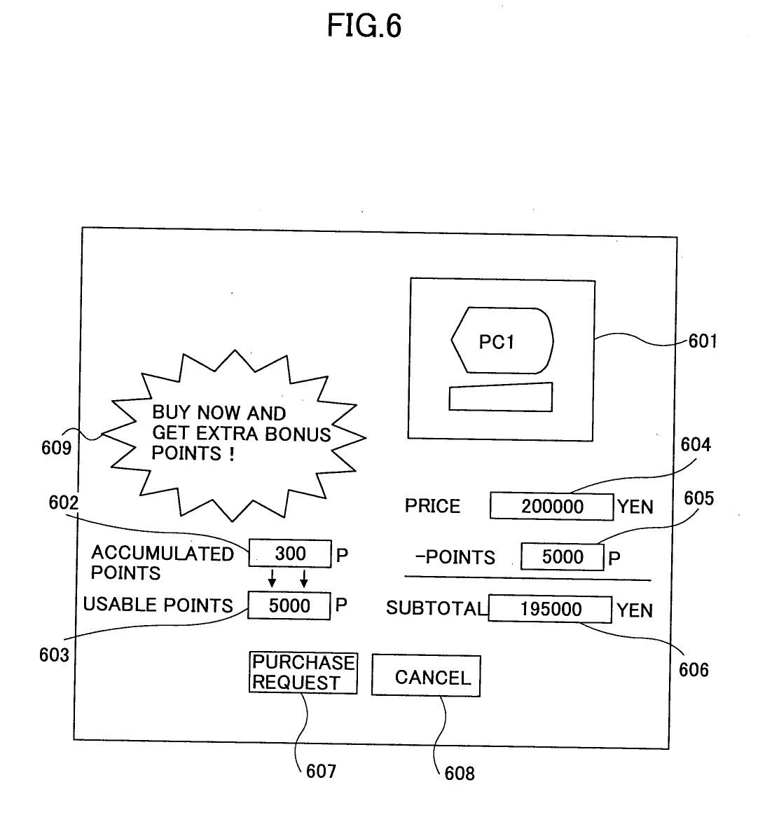

FIG. 1 shows an example of an overall configuration of an online shopping system implementing a point system of the present invention. This online shopping system includes a web server 101 provided by the seller side, a user management information database 102 that stores user management information, a product management information database 103 that stores product management information, a network 104 such as the Internet, and a client 105 implementing a web browser used by a customer that is connected to the system via the network 104. The web server 101 corresponds to a point system server of the present invention, and the client 105 corresponds to a user serving apparatus of the present invention. Also, the client 105 and a screen displayed for a user to select a product that is supplied to the client 105 from the online shopping system in step 402 of FIG. 4, which is described below, make up an item specification unit of the present invention. Further, the user management information database 102 makes up a user point maintaining unit of the present invention, and the web server 101 also corresponds to a user point processing unit of the present invention. Additionally, the product management information database 103 contains conditions relating to the user of the present invention. The client 105 and a transaction screen as shown in FIG. 6 that is supplied to the client 105 from the online shopping system includes a usable points indicator 603, which corresponds to an increased points indicator of the present invention. Also, the client 105 and the transaction screen as shown in FIG. 6 that is supplied to the client 105 from the online shopping system includes a points specifier 605, which corresponds to the points specification unit of the present invention. In the exemplary point system of the present invention shown in FIG. 1, the user accesses the web server 101, which is provided by the seller side, via the network 104 using the web browser of the client 105. In this way, the user can take a look at the products offered by the seller and make a purchase of a desired product. Also, as in a conventional point system, in the point system of the present invention, when a user buys a product, a predetermined number of points are given to this user according to the price of the purchased product. The accumulated points can then be used later on when this user makes another purchase of a product or pays to receive a particular service. In such case, an amount of money corresponding to the number of points used by the user can be subtracted from the price of the product or service being purchased.

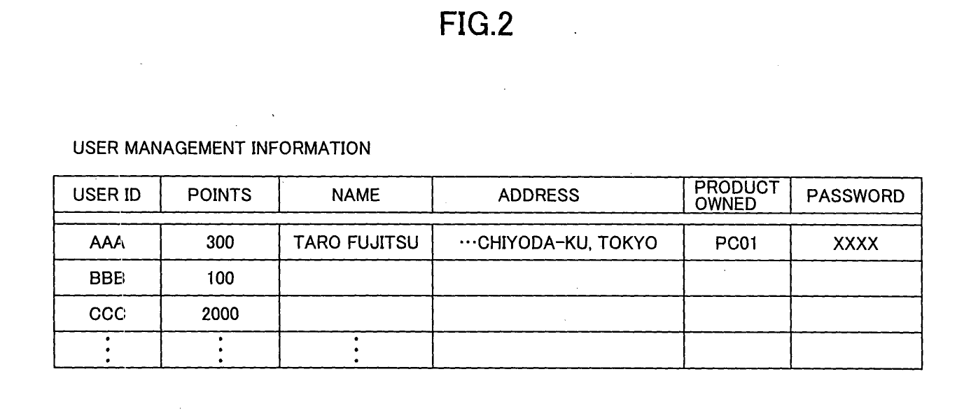

FIG. 2 shows an example of user management information stored in the user management information database 102. The user management information shown in FIG. 2 includes a user ID for identifying the user, accumulated points of the user, a user name, a user address, a product name or number of a product that the user possesses, and a user password, for example.

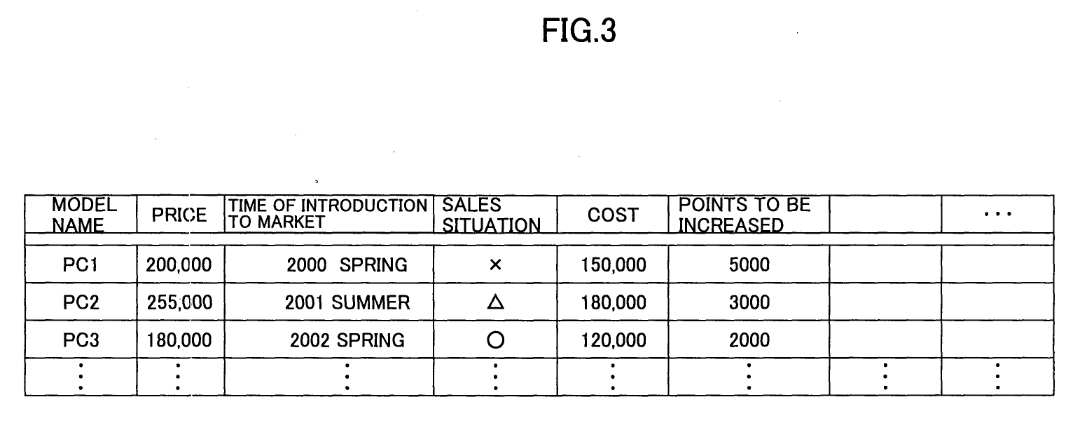

Also, FIG. 3 shows product information of the products sold in the online shopping system stored in the product management information database 103. This product information includes the model name of the product, the price of the product, the time-frame of product introduction to the market, sales situation of the product, the cost of the product, and points to be increased if the product is purchased, for example. Herein, the time-frame of product introduction to the market corresponds to the time when the product first began to be sold on the market. Also, the sales situation shows the relationship between the estimated sales predicted at the beginning of sales and the actual sales performance of the product. For example, in FIG. 3, if the sales performance of the product is above the estimated sales, the sales situation is indicated by a circle ◯, if the sales performance of the product is below the estimated sales but is above a pre-established percentage (e.g. 80%) of the estimated sales, the sales situation is indicated by a triangle Δ, and if the sales performance is lower than the predetermined percentage of the estimated sales, the sales situation is indicated by a cross X.

Also, the points to be increased shown in FIG. 3 indicate the points that will be added to the points the user already has, under certain conditions or unconditionally when the user purchases a particular product. Also, instead of adding the points to be increased to the already accumulated points of the user, the points to be increased may be arranged to replace the already accumulated points of the user.

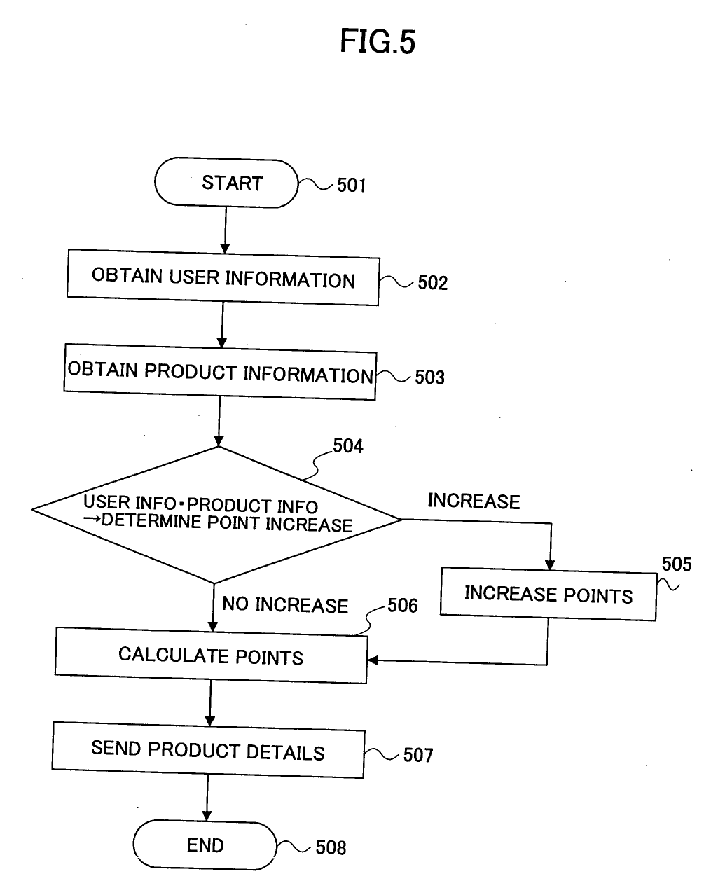

Next, the processes relating to controlling the points of a user when the user purchases a product are described with reference to FIGS. 4 and 5. FIG. 4 shows an operation of the point system according to the present invention, and FIG. 5 shows a flowchart of a process of generating the transaction screen that is a part of the above operation of the point system.

First, in step 401 of FIG. 4, the user logs onto the online shopping system from the web browser screen of the client 105 shown in FIG. 1. The user can log on by inputting his/her user ID (identifier code) and password. When the user logs onto the online shopping system from the web browser screen, the web server 101 shown in FIG. 1 queries the user management information database 102 for user acknowledgement information 421 stored in the user management information database 102. In turn, the user management information database 102 sends back a user ID and password to the web server 101 as the user acknowledgement information 421. The web server 101 identifies the user in step 411 and acknowledges the login of the user if the user ID and the password sent from the client 105 via the network 104 and the user ID and password sent back from the user management information database 102 respectively match. In this way, preparations for the user to access the online shopping system using the web browser of the client 105 are completed.

Next, in step 402, the user selects a product that he/she wishes to purchase from among the products being offered in the online shopping system using the web browser of the client 105. As in the conventional art, the online shopping system may implement a cart system, and in this case, the user may perform an operation of putting the desired product into the cart.

Then, when information indicating the selection of a product is sent to the web server 101 from the web browser of the client 105 via the network 104, the web server 101 generates the transaction screen in step 412. The transaction screen is created using user management information 422 of the user who has selected a product obtained from the user management information database 102 based on the user ID, and product information 423 of the product selected and sent from the web browser of the client 105. The product information 423 can be obtained from the product management information database 103 of FIG. 1. The transaction screen created by the web server 101 includes information indicating details of the product, the price of the product, as well as the usable points of the user that are increased upon the user purchasing the product. The web server 101 sends the transaction screen to the web browser of the client 105 when it completes the generation of this transaction screen.

In the following, the generation of the transaction screen performed in step 412 will be further described with reference to FIG. 5.

FIG. 5 is a flowchart illustrating the process of generating the transaction screen (step 412 of FIG. 4) realized by the web server 101. In step 501, the process of generating the transaction screen is initiated.

In step 502, the web server 101 obtains user information from the user management information database 102. The user information includes the user ID for identifying the user, the accumulated points of the user, the user name, the user address, and the product name or number of the product that the user possesses, for example, which are stored in the user management information database 102.

Next, in step 503, the web server 101 obtains product information of the product selected by the user from the product management information database 103. The product information includes the model name of the product, the price of the product, the time-frame of product introduction to the market, sales situation of the product, the cost of the product, and the points to be increased upon the purchase of the product, for example.

Then, in step 504, the web server 101 determines whether or not the usable points of the user will be increased based on the user information obtained in step 502, and the product information obtained in step 503.

If it is determined in step 504 that the usable points of the user are to be increased upon the purchase of the product, in step 505, the actual number of points to be increased is determined.

In the following, examples of conditions for increasing the points provided to the user and setting the points to be added when the user purchases the product will be described.

In a first embodiment of setting the increased points for a user, for example, points that can be used by a particular user upon purchasing a product during a particular time period may be arranged to correspond to the points to be increased for the particular product that the user wishes to purchase.

In such case, when it is determined in step 504 that one or more conditions to be described below are satisfied, in step 505, the points that can be used by the user for purchasing the product is arranged to correspond to the points to be increased for the particular product the user wishes to purchase.

1. Unconditional. In this way, for example, when a particular user with a particular user ID included in the user management information stored in the user management information database 102 purchases a particular product during a predetermined time period, this user will be able to use the increased points at any time and all the products offered are promoted.

2. If the price of the product the user wishes to purchase is above a predetermined price (e.g. ¥200,000) according to the data of this particular product included in the product information stored in the product management information database 103. In this way, the sale of products within a particular price range that the seller wishes to promote during a particular time period can be effectively promoted.

3. If the time-frame of product introduction to the market included in the product information stored in the product management information database 103 is before a predetermined number of years (e.g. 2 years) ago. In this way, for example, the seller is able to particularly promote the sale of older products.

4. If the sales situation of the product included in the product information stored in the product management information database 103 meets a predetermined condition, such as, if the sales situation of a product is marked by the marks Δ or X, or otherwise, if the sales situation of a product is marked by X. In this way, sales promotion is performed for products of which the sales performances are below the initially predicted sales performance but above a predetermined percentage (e.g. 80%) of the predicted sales, and products of which the sales performances are below this percentage, or otherwise for only the products falling into the latter category.

5. If the accumulated points of the user included in the user management information stored in the user management information database 102 is below a predetermined number of points (e.g. 1000 points). In this way, for example, sales promotion can be directed particularly to users that have fewer points.

In a second embodiment of setting the increased points for a user, for example, the points that can be used when a particular user purchases a product during a particular time period may be arranged to correspond to the total of the points the user currently has and the points to be increased for the particular product the user wishes to purchase.

In such case, as in the above-described first embodiment, when it is determined in step 504 that one or more conditions described below are satisfied, in step 505, the points that can be used when a particular user purchases a product may be arranged to correspond to the total of the points the user currently has and the points to be increased for the particular product the user wishes to purchase.

1. Unconditional. In this way, for example, when a particular user with a particular user ID included in the user management information stored in the user management information database 102 purchases a particular product during a predetermined time period, this user will be able to use the increased points at any time and all the products offered are promoted.

2. If the price of the product the user wishes to purchase is above a predetermined price (e.g. ¥200,000) according to the data of this particular product included in the product information stored in the product management information database 103. In this way, the sale of products within a particular price range that the seller wishes to promote during a particular time period can be effectively promoted.

3. If the time-frame of product introduction to the market included in the product information stored in the product management information database 103 is before a predetermined number of years (e.g. 2 years) ago. In this way, for example, the seller is able to particularly promote the sale of older products.

4. If the sales situation of the product included in the product information stored in the product management information database 103 meets a predetermined condition, such as, if the sales situation of a product is marked by the marks Δ or X, or otherwise, if the sales situation of a product is marked by X. In this way, sales promotion is performed for products of which the sales performances are below the initially predicted sales performance but above a predetermined percentage (e.g. 80%) of the predicted sales, and products of which the sales performances are below this percentage, or otherwise for only the products falling into the latter category.

5. If the accumulated points of the user included in the user management information stored in the user management information database 102 is below a predetermined number of points (e.g. 1000 points). In this way, for example, sales promotion can be directed particularly to users that have fewer points.

On the other hand, when it is determined in step 504 that the points the user can use to purchase a product will not be increased, the process moves on to step 506. In step 506, the number of points that is to be ultimately presented to the user is determined.

Then, in step 507, the web server 101 sends the transaction screen containing detailed information on the product selected by the user as well as the increased points that are determined in the above described manner to the web browser of the client 105 via the network 104. Then, in step 508, the generation process of the transaction screen is completed.

Referring back to FIG. 4, in step 403, the web browser of the client 105 displays the transaction screen generated and sent according to the above described process.

In step 403, the transaction screen, namely, the screen for the user to confirm the purchase of the product or the screen for the user to check the product contained in the cart, indicates that the points that can be used by the user to purchase a product will be increased if the selected product is purchased under a predetermined condition or unconditionally.

FIG. 6 shows an exemplary transaction screen generated according to an embodiment of the present invention, wherein the user with the user ID ‘AAA’ of FIG. 2 purchases the product ‘PC1’ shown in FIG. 3.

The exemplary transaction screen of FIG. 6 includes a desired product indicator 601 indicating the desired product selected by the user AAA in step 402, an accumulated points indicator 602 indicating the points currently held by the user, the usable points indicator 603 indicating the points that can actually be used upon purchasing this product, a product price indicator 604, the points specifier 605 for specifying the points to be used by the user upon purchasing the product, a subtotal indicator 606, a purchase request button 607, a cancel button 608, and an advertisement displayer 609 for promoting product sales. In the example of FIG. 6, the PC1 is indicated at the desired product indicator 601 as the desired product selected by the user AAA in step 402, and the price of this product is indicated as ‘200000’ yen at the product price indicator 604. Also, the points currently maintained by the user AAA of FIG. 2 is indicated as ‘300’ at the accumulated points indicator 602, and the increased points that can actually be used in purchasing the product PC1 is indicated as ‘5000’ at the usable points indicator 603 in accordance with FIG. 3. Thus, according to the transaction screen shown in FIG. 6, the points that can actually be used by the user AAA upon purchasing the product PC1 at this point will be increased from 300 points, which is the number of points currently maintained by the user AAA, to 5000 points.

Further, any desired number of points below the maximum usable number of 5000 points, which corresponds to the increased number of points, may be input to the points specifier 605. In the example of FIG. 6, the product price is 200,000 yen and 5,000 points are assigned to be used for the purchase of the product PC1. In this exemplary point system, 1 point can be converted into 1 yen, and thus, the amount of money that the user is actually required to pay is indicated as ‘195000’ yen in the subtotal indicator 606.

Referring back to FIG. 4, in step 403, if necessary, the user determines the number of points to be used for the purchase of the product from the above provided points. Alternatively, the system may be configured to automatically use all of the available points upon the purchase of the product.

If the user is willing to purchase the product under the conditions displayed on the transaction screen of FIG. 6, the user can make a purchase request to the online shopping system to purchase the product by selecting the purchase request button 607 shown in FIG. 6.

On the other hand, if the user wants to cancel the purchase of the product displayed on the transaction screen of FIG. 6, the user can select the cancel button 608. The purchase request of the product or the cancellation of the purchase selected at the web browser of the client 105 in this manner is sent to the web server 101 via the network 104.

When the purchase request button 607 is selected, the web server 101 obtains product information 424 from the product management information database 103 in step 413 and performs selling procedures according to the product purchase request from the user. The selling procedures include conventional selling procedures such as confirmation of the payment method designated by the user, user verification with the financial institution that is involved in the payment method determined by the user, and product shipping arrangements. Then, the subtotal is calculated according to the points used by the user, and a settlement is made. After the product selling procedures are successfully completed, the online shopping system subtracts the points used for the purchase of the product from the increased points of the user obtained above, and the resulting points are stored in the user management information in the user management information database 102 as the points currently maintained by the user.

Then, a notification of the completion of the settlement is sent to the web browser of the client 105 from the web server 101 via the network 104.

Next, in step 404, the web browser of the client 105 displays the price of the product the user has purchased and the notification of the completion of the settlement procedures to the user.

Further, it is noted that although in the above embodiment, the purchasing of goods has been described, the present invention is not limited to these embodiments, and variations and modifications may be made without departing from the scope of the present invention. For example, the point system according to the present invention may also be used when a user makes a transaction to receive a particular service.

The present application is based on and claims the benefit of the earlier filing date of Japanese priority application No.2002-273180 filed on Sep. 19, 2002, the entire contents of which are hereby incorporated by reference.

What is claimed is:

1. A point system in which predetermined points are generated in response to a purchase of an item being sold comprising:
a user terminal having an item specification unit that is used by a user to specify the item being sold; and
a provider terminal connected to the user terminal via a network, and including:
a user points maintaining unit that is arranged to add the generated points to an already accumulated points of the user and maintain the resulting points of the user; and
a user points processing unit that is arranged to allocate the points of the user maintained in the user points maintaining unit to a subtotal for the purchase of the specified item being sold, wherein:
the user points processing unit is further arranged to be capable of increasing the points of the user maintained in the user points maintaining unit and allocating the increased points to the subtotal for the purchase of the specified item being sold when the user purchases the item being sold during a predetermined time period or in a case where a condition relating to the user satisfies a pre-designated condition.

2. The point system as claimed in claim 1, wherein:
the case in which the condition relating to the user satisfies a pre-designated condition is arranged to be a case in which the item being sold specified by the user corresponds to a pre-designated item.

3. The point system as claimed in claim 1, wherein:
the case in which the condition relating to the user satisfies a pre-designated condition is arranged to be a case in which a price of the item being sold specified by the user corresponds to a pre-designated price.

4. The point system as claimed in claim 1, wherein:
the case in which the condition relating to the user satisfies a pre-designated condition is arranged to be a case in which a time-frame of introduction of the user-specified item to the market corresponds to a pre-designated time.

5. The point system as claimed in claim 1, wherein:
the case in which the condition relating to the user satisfies a pre-designated condition is arranged to be a case in which a sales situation of the item being sold specified by the user corresponds to a pre-designated sales situation.

6. The point system as claimed in claim 1, wherein:
the case in which the condition relating to the user satisfies a pre-designated condition is arranged to be a case in which the already accumulated points of the user correspond to pre-designated points.

7. The point system as claimed in claim 1, further comprising:
an increased points indicator that is arranged to indicate the increased points of the user.

8. A method of providing an item being sold in which predetermined points are generated in response to a purchase of an item being sold that is specified by a user using an item indicating unit, said method comprising:
a user points maintaining step of adding the generated points to already accumulated points of the user and maintaining the resulting points of the user; and
a user points processing step of allocating the points of the user maintained in the user points maintaining step to a subtotal for the purchase of the specified item being sold; wherein:
the user points processing step is further arranged to be capable of increasing the points of the user maintained in the user points maintaining step and allocating the increased points to the subtotal for the purchase of the specified item being sold when the user purchases the item being sold during a predetermined time period or in a case where a condition relating to the user satisfies a pre-designated condition.

9. The method of providing an item being sold as claimed in claim 8, wherein:
the case in which the condition relating to the user satisfies a pre-designated condition is arranged to be a case in which the item being sold specified by the user corresponds to a pre-designated item.

10. The method of providing an item being sold as claimed in claim 8, wherein:
the case in which the condition relating to the user satisfies a pre-designated condition is arranged to be a case in which a price of the item being sold specified by the user corresponds to a pre-designated price.

11. The method of providing an item being sold as claimed in claim 8, wherein:
the case in which the condition relating to the user satisfies a pre-designated condition is arranged to be a case in which a time-frame of introduction of the user-specified item to the market corresponds to a pre-designated time.

12. The method of providing an item being sold as claimed in claim 8, wherein:
the case in which the condition relating to the user satisfies a pre-designated condition is arranged to be a case in which a sales situation of the item being sold specified by the user corresponds to a pre-designated sales situation.

13. The method of providing an item being sold as claimed in claim 8, wherein:
the case in which the condition relating to the user satisfies a pre-designated condition is arranged to be a case in which the already accumulated points of the user correspond to pre-designated points.

14. The method of providing an item being sold as claimed in claim 8, further comprising:
an increased points indicating step of indicating the increased points of the user.

15. A point system server in which predetermined points are generated in response to a purchase of an item being sold, specified by a user serving apparatus that includes an item specification unit, said point system server comprising:
a user points maintaining unit that is arranged to add the generated points to an already accumulated points of the user and maintain the resulting points of the user; and
a user points processing unit that is arranged to allocate the points of the user maintained in the user points maintaining unit to a subtotal for the purchase of the specified item being sold; wherein:
the user points processing unit is further arranged to be capable of increasing the points of the user maintained in the user points maintaining unit and allocating the increased points to the subtotal for the purchase of the specified item being sold when the user purchases the item being sold during a predetermined time period or in a case where a condition relating to the user satisfies a pre-designated condition.

16. The point system server as claimed in claim 15, wherein:
the point system server is connected to the user serving apparatus via a network.

17. A user serving apparatus included in a point system, comprising:
an item specification unit that is arranged to specify an item being sold that is to be purchased; and
a points specification unit that is arranged to specify points that are to be allocated to a subtotal for purchasing the item being sold specified by the item specification unit, and make notification of the specified points to a point system server in which predetermined points are generated in response to the purchase of the specified item being sold, said point system including:
a user points maintaining unit that is arranged to add the generated points to an already accumulated points of the user and maintain the resulting points of the user; and
a user points processing unit that is arranged to allocate the points of the user maintained in the user points maintaining unit to the subtotal for the purchase of the specified item being sold, said user points processing unit further being arranged to be capable of increasing the points of the user maintained in the user points maintaining unit and allocating the increased points to the subtotal for the purchase of the specified item being sold when the user purchases the item being sold during a predetermined time period or in a case where a condition relating to the user satisfies a pre-designated condition.
